(19) United States
(12) Patent Application Publication
(10) Pub. No.: US 2023/0182602 A1
(43) Pub. Date: Jun. 15, 2023

(54) Electric vehicle enhancement

(71) Applicant: Mark Ogram, Tucson, AZ (US)

(72) Inventor: Mark Ogram, Tucson, AZ (US)

(21) Appl. No.: 17/803,922

(22) Filed: Jan. 23, 2023

Related U.S. Application Data
(63) Continuation of application No. 17/803,248, filed on Mar. 31, 2022.
Application No. 17/803,248 is a continuation-in-part of application No. 17/300,768, filed on Oct. 29, 2021, now abandoned.
Application No. 17/300,768 is a continuation-in-part of application No. 17/300,357, filed on May 24, 2021, now Pat. No. 11,220,186.

(51) Int. Cl. B60L 53/62; B60L 53/18; B60L 58/13; B60L 53/50; B60L 53/30; B60L 50/60

(52) U.S. Cl. CPC B60L 53/62; B60L 53/18; B60L 58/13; B60L 53/50; B60L 53/305; B60L 50/60; B60L 53/30

(57) ABSTRACT

A sensing mechanism which activates/deactivates an exterior motor for an electric vehicle which is powered by rechargeable batteries. The sensing mechanism uses the receptacle used to charge the electric vehicle as a source to monitor the status of rechargeable battery and to start the ignition of the exterior motor.

### PRIORITY

This is a continuation of U.S. patent number Ser. No. 17/803,248, entitled “Electric Car Sensor” filed on Mar. 31, 2022; which was a continuation-in-part of U.S. patent Ser. No. 17/300,768, filed on Oct. 29, 2021, and entitled “Range Enhancing Platform”; which was a continuation in part of U.S. patent application Ser. No. 17/300,357, entitled “Range Enhancing Mechanism” filed on May 24, 2021, now U.S. Pat. No. 11,220,186.

### BACKGROUND OF THE INVENTION

This invention relates generally to electrical vehicles and more particularly to a ready and fast mechanism to provide an on-the-go “recharge” to the vehicle.

Electric vehicles are touted as being environmentally friendly and as being more economical to operate. Estimates are that per-mile costs for fuel/energy, the electric vehicle is about half the cost of gasoline vehicles. With the cost of gasoline and diesel rising, the consumer is evaluating the electric vehicles in greater depth.

The biggest limiting factor for the potential consumer of an electric vehicle, is the limited range between recharging the battery. Often this range is only 300-400 miles which is more than suitable for suburban driving, but for interstate trips, the range limitation becomes problematic.

Further, if the battery becomes spent or exhausted, then the vehicle is left completely stranded. At the present time, the only solution is a tow to the next charging station.

It is clear there is a need to improve electric vehicles in order to make them acceptable to the general public.

### SUMMARY OF THE INVENTION

The invention provides an assist apparatus for an electric vehicle which is powered by rechargeable batteries. To assist in the range of the electric vehicle, a platform is secured or towed by the vehicle. On the platform is a hydrocarbon motor that generates electricity. The hydrocarbon motor is activated, either manually via a handheld transmitter, via a switch connected to the hydrocarbon motor, or automatically by sensors in the electric vehicle to charge the rechargeable batteries within the electric vehicle.

In general terms, the invention involves an assist apparatus for an electric vehicle. The assist apparatus, when operating, provides a stream of electricity to the rechargeable battery on the electric vehicle. It is contemplated that the assist apparatus would not be used for traditional commutes but would be applicable for longer distances past the range of the electric vehicle's rechargeable battery, typically through a rental agency.

There are many versions of power systems used to recharge the battery. These include, but not limited to: U.S. Pat. No. 10,989,273, entitled “Power Unit” issued to Obrist et al. on Apr. 27, 2021; incorporated hereinto by reference.

The assist apparatus involves a platform which is securable to the vehicle (hanging on the bumper, attached to the towing slide, or via trailer) on which a traditional internal combustion engine is mounted. The internal combustion engine powers a generator and provides electricity to re-charge the rechargeable battery traditionally found in an electric vehicle via an electrical cable/connection.

The preferred embodiment has the engine mounted on a cantilever platform from the rear of the vehicle.

Those of ordinary skill in the art readily recognize a variety of electrical connections which may be employed in the context of charging the rechargeable battery, including, but not limited to: U.S. Pat. No. 0,967,750, entitled “System and Method for Charging Plug-in Hybrid Vehicle” issued to Lee et al. on Apr. 6, 2021; U.S. Pat. No. 10,989,087, entitled “Plug-In Hybrid Vehicle” issued to Yokoi on Apr. 27, 2021; all of which are incorporated hereinto by reference.

To operate the internal combustion engine, the preferred method is via a radio frequency handheld mechanism. The user, when they want to provide additional charge to the rechargeable battery, activates the internal combustion engine using the handheld transmitter; when done, the same radio frequency handheld transmitter is used to deactivate the internal combustion engine. In this way, the rechargeable battery is charged “on the go” without having to stop at a charging station.

Radio Frequency mechanisms are well known in the art for activating engines. These include: U.S. Pat. No. 6,559,558, entitled “Smart Car Starter” issued to Quesnel et al. on May 6, 2003; U.S. Pat. No. 7,140,338, entitled “Snowmobile Remote Ignition System” Issued to Janisch on Nov. 28, 2006; U.S. Pat. No. 10,189,442, entitled “Remote Vehicle Starter and Appliance Activation System” issued to Ford et al. on Jan. 29, 2019; all of which are incorporated hereinto by reference.

Further, should the electric vehicle become stranded due to a depleted rechargeable battery, a service provider is able to bring the assist apparatus to the site and recharge the battery, allowing the previously stranded driver to continue.

Besides the handheld mechanism described above, in another embodiment, the electric vehicle is equipped with a sensor on the rechargeable battery which activates, when needed, the assist apparatus.

A variety of mechanisms are used to monitor the rechargeable battery including, but not limited to: U.S. Pat. No. 10,983,166, entitled “Estimation of Battery Parameters” issued to Hellgren et al. on Apr. 20, 2021; U.S. Pat. No. 10,994,719, entitled “Method and Device for Controlling Hybrid Vehicle” issued to Obata on May 4, 2021; U.S. Pat. No. 11,001,266, entitled “Hybrid Vehicle Drive System” issued to Kasahara on May 11, 2021; all of which are incorporated hereinto by reference.

An important aspect of the present invention is the ability to protect the assist apparatus from damage from impact with either another moving vehicle (being rear ended) or by backing into a solid object (e.g. a wall). To provide this protection, a secondary bumper (preferably either metal or hardened rubber) issued. The preferred bumper is U-shaped and arranged around three sides of the platform.

In one embodiment of the invention, the secondary bumper contacts the primary bumper on the electric vehicle allowing the electric vehicle's bumper to provide more endurance to the secondary bumper.

In another embodiment, springs extend from the “legs” of the U-shaped secondary bumper to engage (either on impact or all the time) with the vehicle's bumper. The use of springs diminishes the possibility of doing serious damage on what would be considered a “minor” impact.

In yet another embodiment of the secondary bumper, collapsible cylinders are use in lieu of the springs. These collapsible cylinders are crushable on impact and are readily replaced later.

As noted earlier, the platform and the assist apparatus are securable to the bumper (hung from the bumper), are supported by a slide hitch receptacle, or on a small trailer that is pulled by the electric vehicle. All of these embodiments make the present invention ideal for commercialization through a rental organization such as an establishment that rents/leases cars and other items for over the road travel.

Those of ordinary skill in the art readily recognize a variety of trailer mechanisms, including, but not limited to those described in: U.S. Pat. No. 8,562,011, entitled “Utility Trailer” issued to Smith on Oct. 22, 2013; U.S. Pat. No. 10,308,158, entitled “Utility Trailer with Movable Bed” issued to Quenzi et al. on Jun. 4, 2019; all of which are incorporated hereinto by reference.

Slide attachments for towing tailers are also well known in the art and include: U.S. Pat. No. 10,099,524, entitled “Adjustable Trailer Hitch” issued to Laundry on Oct. 16, 2018; and U.S. Pat. No. 10,696,112, entitled “Lightweight Hitch Structure” issued to Meingast et al. on Jun. 3, 2020; U.S. Pat. No. 10,836,225, entitled “Detachable Receiver” issued to Robinson et al. on Nov. 17, 2020; all of which are incorporated hereinto by reference.

Ideally, the internal combustion engine uses a variety of carbon based fuels such as gasoline, diesel, propane, and natural gas.

In one embodiment of the invention, the charging engine is mountable to the roof of the electric vehicle. In this embodiment, the driver of the vehicle does not have to change their driving/parking habits as the vehicle's outside dimensions remain the same.

Although the above discussion related to the use of hydrocarbons to power the internal combustion charging station, another embodiment uses hydrogen preferably in a fuel cell setting. This embodiment is safer when a crash occurs.

Those of ordinary skill in the art readily recognize a variety of such engines, including, but not limited to those described in: U.S. Pat. No. 6,264,856, issued on Jul. 24, 2001, to Autenieth et al. and entitled “Three-Step Reforming Reactor especially suited for Mobile Fuel Cell”; U.S. Pat. No. 7,045,232, issued May 16, 2006, to Duebel et al. and entitled “Fuel Cell System and Method for Producing Electric Energy using a Fuel Cell System”; and, U.S. Pat. No. 7,160,638, issued on Jan. 9, 2007, to Duebel et al. and entitled “Fuel Cell System and Method for Generating Electrical Energy using a Fuel Cell System”; all of which are incorporated hereinto by reference.

In an embodiment of the invention, the electric vehicle's receptacle (used to charge the electric vehicle) provides the connection to the recharging external motor as discussed above. This embodiment utilizes the receptacle itself as a monitoring source for the status (level of charge) of the rechargeable battery.

This monitor, by accessing the level of charge within the rechargeable battery, is able to activate (through the ignition process) the charging station when the rechargeable battery's level falls below a given threshold; and conversely, to deactivate (stop) the charging station when the charge has met a predefined level.

In this manner, to install the external charging system to an electric vehicle, the charging station merely has to be “plugged into” the receptacle and the monitoring of the rechargeable battery is established. The electrical cable, with connector, extends from the charging station to the receptacle.

The sensing mechanism used for the ignition of the charging station is optionally placed within the connector (at the end of the cable) secured to the receptacle; or, is attached to the charging station itself.

Those of ordinary skill in the art readily recognize a variety of ignition mechanisms which can be used in this context, including, but not limited to those described in: U.S. Pat. No. 11,217,838, issued Jan. 4, 2022, Fairweather et al. and entitled “Management System for Commercial Electric Vehicles”; and, U.S. Pat. No. 11,233,418, issued Jan. 25, 2022, to Chang and entitled “Charging Termination Control Module and Battery Charger Circuit”; both of which are incorporated hereinto by reference.

In some embodiments of the electric vehicle, the receptacle is located within the trunk of the electric vehicle. This position allows the electrical cable from the charging station to pass under the trunk lid to the receptacle for protection from weather conditions.

Another embodiment of the electric vehicle positions the receptacle at the very back of the electric vehicle. This position provides for easy connection with the charging station when the charging station is positioned on the cantilevered platform or from the trailer mounted charging station.

The invention, together with various embodiments thereof, will be explained in detail by the accompanying drawings and the following descriptions thereof.

### DRAWINGS IN BRIEF

FIGS. 1A and 1B are side and top views of the preferred embodiment of the invention wherein the assist system is secured to the vehicle via a towing slide mount.

FIG. 2 is side view in which the assist system is being towed as a trailer.

FIG. 3 illustrates the internal combustion engine of the present invention.

FIG. 4 illustrates the preferred secondary bumper protection of the assist system in which the secondary bumper contacts the bumper on the vehicle.

FIGS. 5A and 5B illustrate two embodiments which are meant to reduce damage due to impact of the secondary bumper.

FIG. 6 illustrates an embodiment of the invention in which the charging engine is mounted on the roof of the vehicle.

FIG. 7 illustrates the interconnection between the charging motor and the receptacle on the electric vehicle.

FIGS. 8A and 8B illustrate alternative placements for the connector for the electric vehicle.

FIG. 9 is an electrical schematic of the connector/ignition mechanism.

### DRAWINGS IN DETAIL

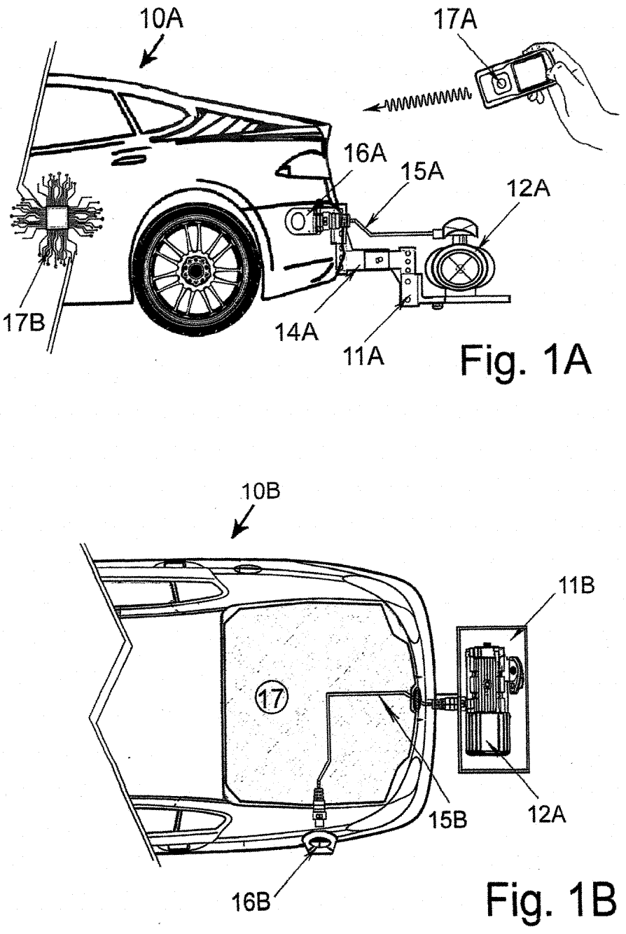

FIGS. 1A and 1B are side and top views of the preferred embodiment of the invention wherein the assist system is secured to the vehicle via a towing slide mount.

Referring to FIG. 1A, vehicle 10A has a slide mount 14A secured thereto. Platform 11A is secured into slide mount and presents a foundation for the mounting of motor/generator 12A. Electrical energy from motor/generator 12A is fed through electrical cable 15A which is connected to receptacle 16A of the electric vehicle 10A.

Receptacle 16A is the traditional connector used to recharge the rechargeable battery (not shown) within vehicle 10A. Unlike the illustration, in the preferred embodiment, receptacle 16A is positioned at the rear of vehicle 10A permitting easier connection with electrical cable 15A.

Activation and deactivation of motor/generator 12A is preferably done via radio transmitter 17A which is illustrated exterior to vehicle 10A, but, in the ideal embodiment, the operator of vehicle 10A activates from within vehicle 10A, to activate motor/generator 12A when the operator deems that the rechargeable battery needs to be boosted.

Alternatively, sensor 17B monitors the charge within the rechargeable battery and activates/deactivates motor/generator 12A when needed.

The embodiment, with the electrical connection within vehicle 10A, is illustrated in FIG. 1B. Again, platform 11B is secured to vehicle 10B on which is mounted motor/generator 12A. In this embodiment, electrical cable 15B is passed into trunk 17 to connect with receptacle 16B. Receptacle 16B is optionally created during manufacture of the electric vehicle 10B or is installed as an after-market item.

The embodiment of FIG. 1B provides more protection for the connection between electrical cable 15B and receptacle 16B.

Mounting, and dismounting the assist apparatus to the vehicle is ideally done as a two-step process. In mounting, first the platform is secured to the vehicle and then the motor/generator is secured to the platform. Dismounting is done in the reverse. This two-step process is easier due the component's weight.

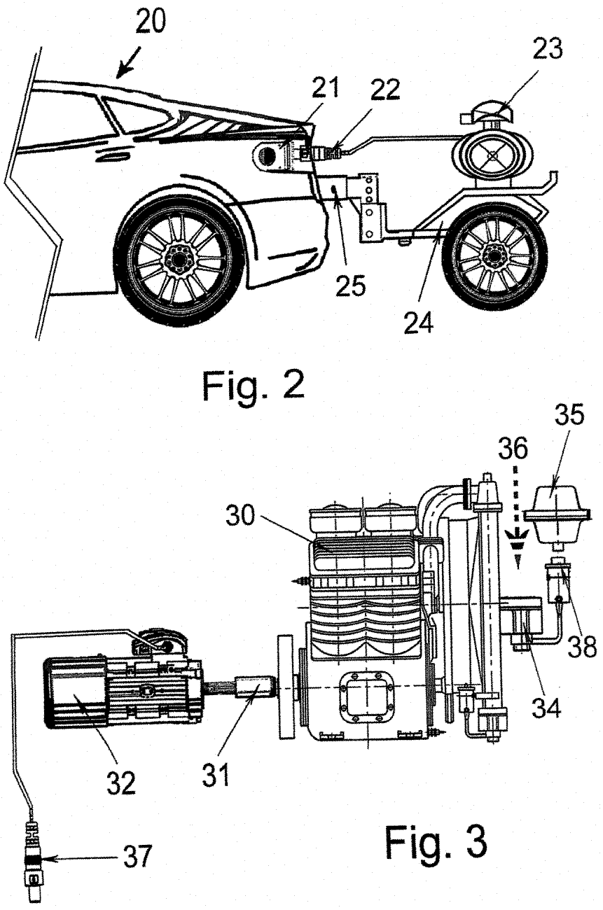

FIG. 2 is side view in which the assist system is being towed as a trailer.

In this embodiment of the invention, vehicle 20 is equipped with a tow bracket 25 which is secured to trailer 24. Motor/generator 23 is carried by trailer 24. Power from the motor/generator 23 is communicated to vehicle 20 and its electrical receptacle 21 via electrical cable 22.

FIG. 3 illustrates the internal combustion engine of the present invention.

In the preferred embodiment, motor 30 is a typical internal combustion engine with its exhaust being muffled for noise concerns. Drive shaft 31 from motor 30 drives generator 32 and the electricity therefrom is communicated to the vehicle (not shown) via electrical cable 37.

Motor 30 is powered by hydrocarbon s such as gasoline and diesel in liquid form. Cannister 35 is used to contain hydrocarbons in the gaseous state such as propane and natural gas. Cannister 35 is securable to inlet 38 as indicated by arrows 36.

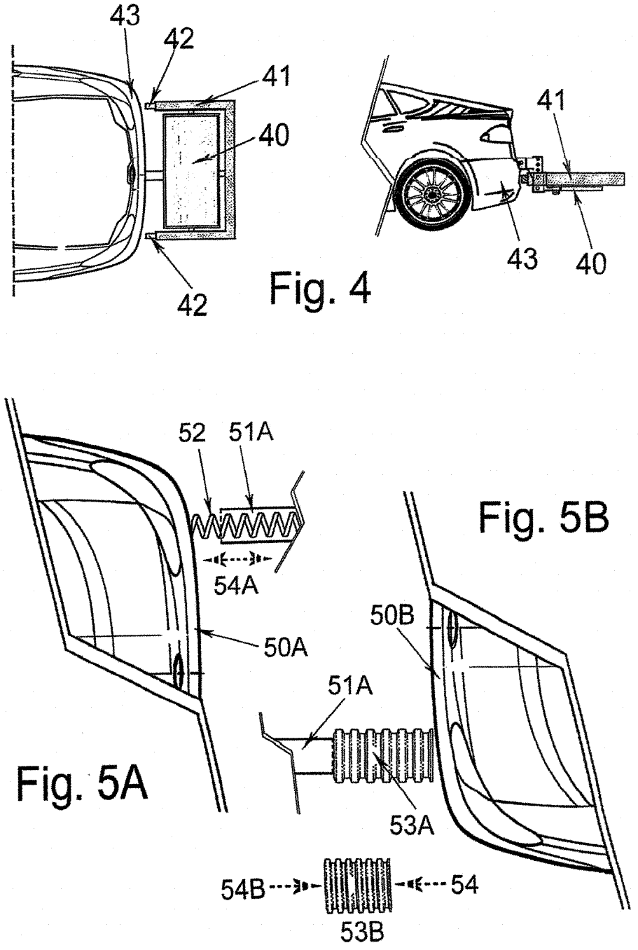

FIG. 4 illustrates the preferred embodiment of the U-shaped secondary bumper protection of the assist system in which the secondary bumper contacts the bumper on the vehicle.

Bumper 40 is generally U shaped with end of the legs 42 proximate to the vehicle's bumper 43. In this embodiment, legs 42 do not contact bumper 43 except during impact. In other embodiments, legs 42 are held firmly against bumper 43.

FIGS. 5A and 5B illustrate two embodiments which are meant to reduce damage due to impact of the secondary bumper.

Referring to FIG. 5A, a top view and side view of the preferred bumper used to protect the motor/generator, leg 51A (only one shown in this illustration) are hollow and contain a spring 52 which extends from leg 51A so that on impact with the bumper, leg 51A is forced (arrow 54A) toward the electric vehicle's bumper 50A, allowing spring 52 to absorb the impacts force to minimize damage to bumper protecting the motor generator.

In FIG. 5B, a collapsible cannister 53A is secured to leg 51A. When the leg 51A and cannister 53A, are pressed against the vehicle's bumper 50B, collapsible cannister “crumbles” 53B as shown by arrow 54B. This crumbling absorbs the impact force to minimize damage.

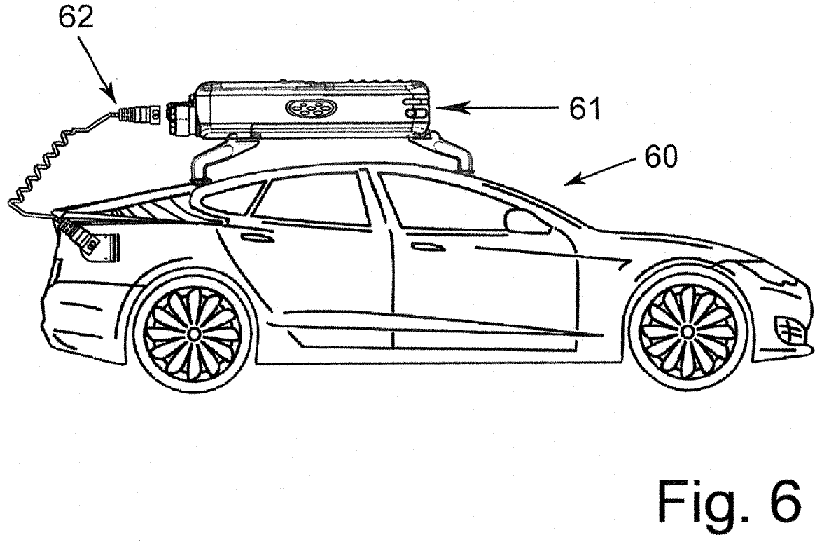

FIG. 6 illustrates an embodiment of the invention in which the charging engine is mounted on the roof of the vehicle.

In this embodiment, platform and charging engine 61 are mounted on the roof of vehicle 60. Power from charging engine 61 is communicated to the battery (not shown) within the vehicle 60 via electrical cable.

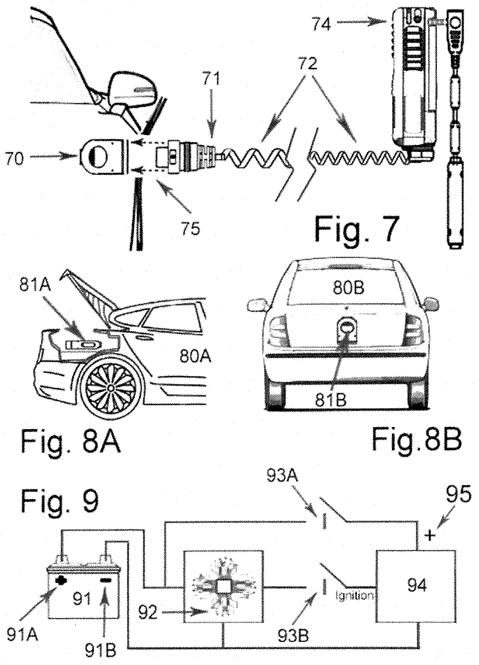

FIG. 7 illustrates the interconnection between the charging motor and the receptacle on the electric vehicle.

Charging receptacle 70 is mounted to the electric vehicle. Connector 71, with electrical cord 72, connects with charging receptacle 70 as shown by arrows 75. This connection allows the ignition mechanism to monitor the condition of the rechargeable battery within the electric vehicle.

When the rechargeable battery within the electric vehicle falls below a threshold level, the automatic ignition system activates charging motor 73. In one embodiment, the automatic ignition system is contained within connector 71; in another embodiment, the automatic ignition system is contained within container 74, secured to the charging motor 73 itself.

The automatically activated ignition mechanism activates the charging station 73 when an electrical condition of the rechargeable battery of the electric vehicle, as sensed from the charging receptacle 70, is below a predetermined threshold, and deactivates the charging station 73 when the electrical condition exceeds a predefined level.

FIGS. 8A and 8B illustrate alternative placements for the connector for the electric vehicle.

As shown in FIG. 8A, charging receptacle 81A is contained within a trunk of the electric vehicle 80A. In FIG. 8B, charging receptacle 81B is located at a rear of the electric vehicle.

FIG. 9 is an electrical schematic of the connector/ignition mechanism.

The connector/ignition mechanism monitors the vehicle battery 91 via the charging receptacle's positive 91A and negative 91B connections.

Positive 91A communicates with the potentiometer 92 which determines if the rechargeable battery within the electric vehicle is within a predetermined range (a threshold and a predefined level). If the level of the rechargeable battery falls below the threshold, the potentiometer 92 causes remote switches 93A and 93B to close.

Remote switch 93B serves as an ignition for charging motor 94; remote switch 93A communicates the electricity 95 from charging motor 94 back to the rechargeable battery.

When the desired level of recharging of the rechargeable battery has been obtained, this condition is sensed by potentiometer 92 and remote switches 93A and 93B are opened.

It is clear that the present invention provides for an improvement for electric vehicles in order to make these vehicles more acceptable to the general public.

What is claimed is:

1. An electric vehicle charging system comprising:
a) an electric vehicle powered solely by a rechargeable battery, said electric vehicle having a receptacle connectable to a first charging cable;
b) a charging station temporarily secured to, and transported by the electric vehicle, said charging station having a second charging cable connectable to the receptacle; and,
c) a status sensor secured to the second charging cable, said status sensor monitoring a charged status of the rechargeable battery, said status sensor selectively activating the charging station based upon the charged status.

2. The electric vehicle charging system according to claim 1, wherein said charging station communicates electricity to the receptacle via the second charging cable.

3. The electric vehicle charging system according to claim 2, wherein the automatically activated ignition mechanism activates the charging station when the charged status is below a set threshold, and deactivates the charging station when the electrical charged status exceeds a predefined level.

4. The electric vehicle charging system according to claim 3, wherein the receptacle on the electric vehicle is located within a trunk of the electric vehicle.

5. The electric vehicle charging system according to claim 3, wherein the receptacle on the electric vehicle is located at a rear of the electric vehicle.

6. The electric vehicle charging system according to claim 3, wherein the status sensor is contained within the second charging cable.

7. The electric vehicle charging system according to claim 6, wherein the charging station is securable to the electric vehicle via a towing slide secured to the electric vehicle.

8. The electric vehicle charging system according to claim 6, wherein the charging station is mounted on a trailer secured to the electric vehicle.

9. The electric vehicle charging system according to claim 6, wherein the charging station is a hydrocarbon powered engine.

10. The electric vehicle charging system according to claim 6, wherein the charging station is a rechargeable battery.

11. An electric vehicle assembly, said electric vehicle being powered solely by a rechargeable battery connected to a charging receptacle, said assembly comprising:
a) a charging station temporarily secured to, and transported by, the electric vehicle;
b) an electrical connection secured to the charging receptacle and an electrical cable communicating between the charging receptacle and the charging station; and,
c) an ignition mechanism communicating with the charging receptacle and generating a charged status of the rechargeable battery, said ignition mechanism selectively activating said charging station based on the charged status.

12. The electric vehicle assembly according to claim 11, wherein the automatically activated ignition mechanism is contained within the electrical connection.

13. The electric vehicle assembly according to claim 12, wherein the charging station is securable to the electric vehicle via a towing slide secured to the electric vehicle.

14. A charging station combination adapted to selectively generate electricity, and wherein the charging station combination is transported by, and exterior to, an electric vehicle powered solely by a rechargeable battery, said electrical vehicle having a charging receptacle communicating electricity to an internal battery for powering the electric vehicle, said charging station combination comprising:
a) an electrical connector and an electrical cable combination selectively communicating electricity between the charging receptacle, and the charging station; and,
b) an automatically activated ignition mechanism selectively activating said charging station based a condition of the rechargeable battery as sensed via the electrical cable.

15. The charging station combination according to claim 14, wherein the automatically activated ignition mechanism is located at the charging station, said automatically activated ignition mechanism identifying the condition of the rechargeable battery via the electrical cable.

16. The charging station combination according to claim 15, wherein the automatically activated ignition mechanism is contained within the electrical connector.

17. The charging station combination according to claim 14, wherein the charging station is a hydrocarbon powered engine.
